(19) United States
(12) Patent Application Publication
(10) Pub. No.: US 2009/0074936 A1
(43) Pub. Date: Mar. 19, 2009

(54) ENERGY BEVERAGE

(76) Inventors: James C. Schmidt, Grosse Point Park, MI (US); Thomas Morley, Harrison Township, MI (US); Thomas F. Morse, Lake Village, MI (US)

Correspondence Address: FALKOWSKI PLLC, P.O. BOX 650, NOVI, MI, 48376-0650, US

(21) Appl. No.: 11/856,705

(22) Filed: Sep. 17, 2007

(51) Int. Cl. A23L 2/52

(52) U.S. Cl. 426/590

(57) ABSTRACT

A drink that can be of high nutritional value and that provides sustained energy for a longer period of time. Stamina and mental focus can be enhanced without escalating blood sugar. Protein can be included for muscle nutrition. Low glycemic carbohydrates can be provided energy. Amino acids can be included to promote metabolic functions. Antioxidants can be included to enhance cell health. Botanicals can be included to enhance nutritional elements.

### BACKGROUND OF INVENTION

The invention relates generally beverages. More specifically, the invention relates to nutritional beverages that provide added energy to the consumer of the beverage (collectively the “beverage”).

Prior art “energy drinks” typically suffer from a variety of weaknesses. One common weakness is that the energy provided by the beverage is short lasting, and resulting in a short spurt of energy that begins to actually reduce the energy of the drinker after a couple of hours. Nonetheless, those skilled in the existing art are apparently convinced that an energy drink requires high amounts of high glycemic carbohydrates.

### SUMMARY OF THE INVENTION

The invention relates generally beverages. More specifically, the invention relates to nutritional beverages that provide added energy to the consumer of the beverage (collectively the “beverage”).

The beverage can be created using a variety of different ingredients and a variety of different processes.

### BRIEF DESCRIPTION OF THE DRAWING

The following drawings illustrate different examples and embodiments of the system:

FIG. 1 is a chart illustrating some of the ingredients that can be used to make the beverage, and how those components and corresponding attributes compare to other prior art drinks.

FIG. 2 is a chart illustrating some of the ingredients that can be used to make the beverage, and ranges for those components.

The beverage can be more fully understood upon reading the following detailed description.

### DETAILED DESCRIPTION

I. Overview

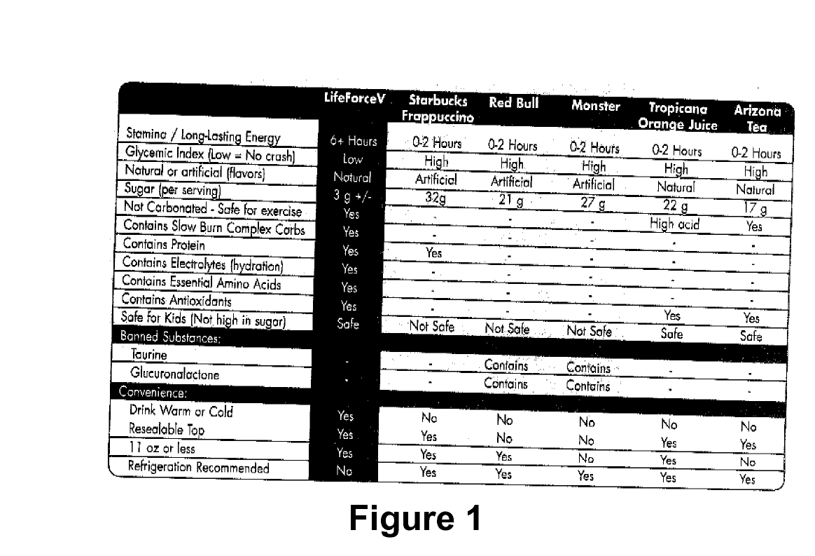

The beverage can be a great tasting natural blend of fruit juices, proteins & protein isolates, protein-based Amino Acids, low Glycemic carbohydrates, Vitamins, Antioxidants, Botanicals and other active ingredients which promote nutritional absorption into the body. The beverage can include unique blends of ingredients that enhance nutritional well being with increased stamina and mental focus without escalating blood sugar. Many of the advantages of the beverage are identified in FIG. 1.

The beverage can deliver superior nutritional values in a great tasting natural beverage with low Glycemic Index.

This beverage creates a new beverage category because it delivers a variety of advantages without the corresponding disadvantages traditionally considered to by synonymous and attributes w. It delivers a broad range of nutrients from Vitamins, Amino Acids, Proteins, low Glycemic Index carbohydrates, electrolytes & antioxidants which spans over existing beverage offerings. The beverage has many attributes that contrast favorably with various drink categories as provided below:
Superior Great Tasting Flavor to promote consumption of nutritional package that follows
Natural and/or organic fruit juices and purees for their taste and inherent nutritional values
Protein for muscle nutrition
Low glycemic carbohydrates for energy
Electrolytes for hydration
Amino Acids to promote metabolic functions
Antioxidants to enhance cell health
Botanicals to enhance nutritional elements

II. Attribute-Function Advantages

This beverage creates a new “Fully Functional Beverage” category of beverages. It can deliver a broad range of nutrients from Vitamins, Amino Acids, Proteins, low GI carbohydrates, electrolytes & antioxidants which spans over existing beverage offerings.

This beverage can displace or outperform existing drinks by delivering superior and broader nutritional profiles as follows:
Fruit Juices in prior art—in contrast the beverage can have a lower volume of carbohydrates and broad nutritional profile beyond juices
Hydrating sports drinks in prior art—in contrast the beverage can have equal or greater hydration values plus broad nutritional profile beyond hydration
Protein sports drinks in prior art—in contrast the beverage can have a low GI, with broad nutritional profile beyond these protein based drinks
Energy drinks in prior art—in contrast the beverage through natural ingredients promotes natural stamina and does NOT contain stimulants such as Taurine, Glucuronalactone, Creatine and other stimulants
Coffee & Tea beverages in prior art—in contrast the beverage has a low GI, with broad nutritional profile beyond these drinks
Soft Drinks in prior art—in contrast the beverage has a low GI, with broad nutritional profile beyond soft drinks
Flavored Waters in prior art—in contrast the beverage has a low GI, with broad nutritional profile beyond these drinks
Vitamin Waters—beverage has a broad nutritional profile beyond these beverages

The beverage can displace or outperform existing drinks with limited nutritional values. The prior art and their relative nutritional disadvantages or shortcomings are listed below in contrast to the beverage:
Fruit Juices—high volume of carbohydrates and limited other nutritional benefits. Limited Vitamins & Antioxidants, No Amino Acids, Proteins, low GI carbohydrates & electrolytes
Hydrating sports drinks—typically high volume of carbohydrates and limited other nutritional benefits beyond electrolytes. No Vitamins, Antioxidants, Amino Acids, Proteins, low GI carbohydrates.
Protein sports drinks—Although high in protein they are typically high in carbohydrates with limited other nutritional benefits. Limited Vitamins, Antioxidants, Amino Acids & electrolytes.
Energy drinks—Contain Taurine, Glucuronalactone, Creatine and other stimulants banned in many markets. Limited Vitamins, Antioxidants & Amino Acids, No Protein, low GI carbohydrates and electrolytes.
Coffee & Tea drinks—Limited nutritional profile beyond caffeine or tea antioxidants. No Vitamins, broad Antioxidants, Amino acids, proteins, low GI carbohydrates
Soft Drinks—Typically high in carbohydrates and absolutely no nutritional benefits. No Vitamins, Antioxidants, Amino acids, Protein, Low GI carbohydrates or electrolytes.
Flavored Waters—No nutritional benefits. No Vitamins, Antioxidants, Amino acids, Protein, Low GI carbohydrates or electrolytes.
Vitamin Waters—Little Vitamin benefits but nothing else. No Amino acids, Protein, Low GI carbohydrates

FIG. 1 provides additional attributes that can make the beverage desirable, and FIG. 1 ties some of those attributes to ingredients in the beverage. Ingredients are discussed both above and below.

III. Ingredients

The beverage can be made primarily or even exclusively of natural nutritional ingredients that can be readily absorbed into the bloodstream and absorbed into the body.

Those skilled in the prior art declare the importance of High GI carbohydrates as fuel. Low GI carbohydrates are included as an after thought only to extend their “exercise” action. Prior “sports drink” art has always been to provide carbohydrate delivery, and lots of it. Although some current drinks now have protein added they all have 30 to 90 grams of carbohydrates in a serving. Prior art teaches to deliver carbohydrates and lots of them to fuel exercise and energy. High GI carbohydrates/sugars that are not used in exercise are stored through conversion to fat which is bad for the average person using “sports drinks” as a beverage.

A 10 oz serving of the beverage can often have approximately 8 grams or lower threshold of carbohydrates per serving, a threshold significantly lower than typical drinks.

The existing art teaches away from low carbohydrate energy drinks and low glycemic energy drinks in particular because the convention thinking is that energy comes from carbohydrates, and particularly high glycemic carbohydrates. Carbohydrates are typically used for short term activities, such as basketball, tennis, football, etc. that take a few hours at most to play.

Most sports, even “endurance sports” are no longer than a marathon . . . maybe tour de France as the most daily grueling under 4-5 hours a day. In these cases it's all about delivering a substantial load of fast burn carbohydrates to support the physical effort or replace electrolytes from sweating. The prior art teaches away from the low carbohydrate and low glycemic sports drinks. Thus, existing sports drinks have undesirable side effects; they make the drink sleepy or tired after a couple of hours. This is not a big issue with day time activities or activities that are relatively short activities such as basketball games, marathons, etc. However, the down side of an energy spike is highly disadvantageous for night events or for longer endurance events.

The beverage can include stable, slow-burn carbohydrates combined with other active ingredients to supply dietary nutrition to enhance metabolism and nutrition in order to keep the body and mind functioning at high levels for extended periods of time.

The beverage can be advantageous with respects to every day life including non-physical activities. It can provide superior taste and nutrition and stamina. Low glycemic index carbohydrates can provide energy without “storage” fat.

It is often desirable for the ratio of low glycemic carbohydrates to proteins to be ranges of something around 2.5 to 4.5 part carbohydrates to 1.0 part protein. This ration of carbohydrates to proteins can enhance nutrient uptake. The beverage can include a Vitamin & Amino Acid blend that enhances metabolic energy conversion from carbohydrates and/or fat. Caffeine, ginseng and green tea dilate blood cells to speed things up.

FIG. 1 is a chart illustrating some of the ingredients that can be used to make the beverage, and how those components and corresponding attributes compare to other prior art drinks.

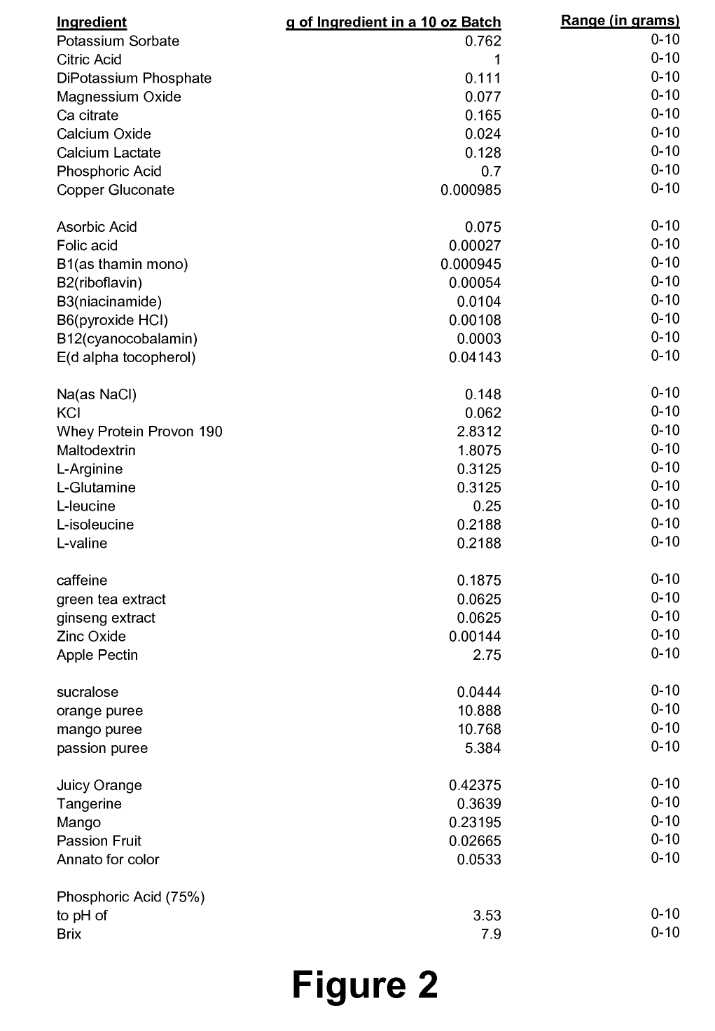

FIG. 2 is a chart illustrating some of the ingredients that can be used to make the beverage, and ranges for those components. In a preferred embodiment, the ranges will not typically deviate by more or less than 20% of mass of the ingredient. In non-preferred alternative embodiments, ingredients can be entirely excluded (0 g).

IV. Method for Making

The beverage can be made by the saturation of dry ingredients and then blending them with liquid juices. It may be bottled by a convention hot fill asceptic, and tort processing procedures to produce a shelf stable product with a minimum shelf life of 12 months.

Some embodiments of the beverage can be created by hydrating the pectins first at 160 degrees F. at typical 3% solution. The proteins can then be added to encapsulate the pectins. The fluid ingredients can then be added together before the final nutritional supplements and flavors are added.

V. Alternative Embodiments

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

1. A beverage, comprising:
a low-glycemic sugar, including at least one of:
a natural flavor;
a slow-burn complex carbohydrate;
a protein;
an electrolyte;
an amino acid; and
an antioxidant.

2. The beverage of claim 1, wherein said beverage does not include: (a) a taurine; (b) a glucuronalactone; and (c) carbonation.
